(19) United States
(12) Patent Application Publication
(10) Pub. No.: US 2004/0036744 A1
(43) Pub. Date: Feb. 26, 2004

(54) Monolithic image forming apparatus print head and fabrication method thereof

(75) Inventors: Seo-Hyun Cho, Seongnam-city (KR); Yung-Gi Kim, Yongin-city (KR); Myung-Song Jung, Gunpo-city (KR); Tae-Kyun Kim, Suwon-city (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-city (KR)

(21) Appl. No.: 10/642,656

(22) Filed: Aug. 19, 2003

(30) Foreign Application Priority Data
Aug. 20, 2002 (KR) 2002-49317

(51) Int. Cl. B41J 2/05

(52) U.S. Cl. 347/65

(57) ABSTRACT

A monolithic bubble ink jet print head and a fabrication method thereof. The print head includes a substrate having a resistance body to heat ink and an ink supply opening penetrating through the substrate, and a chamber/nozzle plate that is formed on the substrate by patterning a photo resist by a photolithography process using a single photo mask having at least two light transmission rates, so that a flow channel structure of an ink chamber, a restrictor, an ink supply channel and a nozzle are simultaneously formed. The fabrication method includes providing a substrate having a resistance body formed on an upper surface thereof to heat ink, forming a photo resist on the substrate having the resistance body, exposing the photo resist to light by using a single photo mask having at least two light transmission rates, and developing the photo resist exposed to the light.

### CROSS-REFERENCE TO RELATED APPLICATIONS

This application claims the priority of Korean Patent Application No. 2002-49317, filed Aug. 20, 2002, in the Korean Intellectual Property Office, the disclosure of which is incorporated herein by reference.

### BACKGROUND OF THE INVENTION

1. Field of the Invention

The present invention relates to a print head of an image forming apparatus such as an ink-jet printer and a fabrication method thereof, and more particularly, to a monolithic bubble-ink jet print head and a fabrication method thereof.

2. Description of the Related Art

Since an image forming device such as an ink-jet printer is excellent in prevention of noise and in obtaining a high resolution and is also capable of performing color printing at a low cost, consumer demand for the ink-jet printer has increased.

Also, with the development of semiconductor technology, a fabrication technology of a print head, which is a main component of the ink-jet printer, has been rapidly developed over the past decade. As a result, a print head having about 300 injection nozzles and capable of providing a resolution of 1200 dpi is being used in a disposable ink cartridge.

FIG. 1 schematically shows a print head 10 of a conventional ink-jet printer.

Generally, ink is supplied from a back surface of a substrate 1 of the print head 10 to a front surface of the substrate 1 through a first ink supply channel 2.

The ink supplied through the first ink supply channel 2 flows along a second ink supply channel 3 defined by a chamber plate 8 and a nozzle plate 9 to reach an ink chamber 4. The ink temporarily stagnating in the ink chamber 4 is instantly boiled by heat generated from a heater 6 disposed under a protective layer 5.

As a result, the ink generates an explosive bubble and, due to the bubble, some of the ink in the ink chamber 4 is discharged outwardly from the print head 10 through a nozzle 7 formed above the ink chamber 4.

In such a print head 10, the chamber plate 8 and the nozzle plate 9 are important factors that affect ink flow, an injection pattern of the ink, an injection frequency, and the like. Accordingly, materials, shapes and fabrication methods of the chamber plate 8 and the nozzle plate 9 have been the subject of considerable research.

A currently used method of fabricating the print head 10 in relation to the chamber plate 8 and the nozzle plate 9 is an adhering method, i.e., separately fabricating a substrate and a nozzle plate, aligning and then adhering these elements to each other by utilizing a photosensitive high molecular thin layer.

The following descriptions are about a fabrication process of the general print head 10 according to the adhering method.

As shown in FIG. 2A, over the silicone substrate 1, which is provided with the heater 6, the protective layer 5, and the first ink supply channel 2, is laminated a dry film resist 8a by heating and pressing, wherein the dry film resist 8a is a negative photo resist of a resin material such as VACREL, RISTON and the like manufactured by DUPONT.

Next, as shown in FIG. 2B, an ultraviolet (UV) light exposure is performed by using a photomask 8′ on which a flow channel structure of an ink chamber, a restrictor, and an ink supply channel is formed. As a result, a latent image 8b is formed on the dry film resist 8a.

After that, as shown in FIG. 2C, the latent image 8b of the dry film resist 8a not exposed to the UV and thus not hardened is etched and removed by a developing process.

As a result, on the substrate 1 is formed a chamber plate 8c having the flow channel structure of the ink chamber, the restrictor and the ink supply channel.

In this state, by adhering a nozzle plate 9a to the chamber plate 8c by heating and pressing, the fabrication of the print head 10 is completed. The nozzle plate 9a is fabricated of a photo resist on a substrate having a mandrel by electrolytic plating or is made of polyimide film forming an ink nozzle by laser ablation.

However, the fabrication method of the print head employing the adhering method has the following problems caused by increases in the integration degree of cells and the number of nozzles.

First, there is a need for a high assembly precision in the adhering process. That is, a photosensitive high molecular thin layer that has to meet a particular condition is required. Also, it is also necessary to precisely align a nozzle plate and a substrate and adhere these elements to each other by utilizing the photosensitive high molecular thin layer, and equipment necessary to perform these operations are also required.

Second, it is often the case that when the substrate and the nozzle plate are adhered to each other by heating and pressing, there occurs a misalignment between the nozzle and the heater due to the difference in a heat expansion coefficient between the substrate and the nozzle plate. Accordingly, uniformity between cells and an injection and a printing performance per each cell in the head are deteriorated.

Third, a fabrication process of a nozzle plate, which has to be separately fabricated, is also complicated. For example, in case of fabricating the nozzle plate by Ni electrolytic plating, a seed layer such as NiV is vapor-deposited on a substrate by a sputter and an evaporator and then is coated with a positive photo resist having a thickness of several microns, for example, 4-8 μm. Next, UV light exposure and developing processes are performed by utilizing a photomask having a nozzle pattern formed therein, and then, with respect to a photo resist mandrel pattern as formed, the Ni electrolytic plating is performed. At this point, a thickness of the Ni nozzle plate and a diameter of the nozzle depend on the condition of a Ni plating liquid containing Ni sulfamic acid, boracic acid, various addition agents, and water, a density of electric current to be supplied to a plating tub, and a plating time. After that, when the Ni nozzle plate is separated from the substrate and washed, a nozzle plate is finally formed.

In order to overcome these disadvantages of the print head fabrication method using the above-described adhering method, a monolithic print head fabrication method has been used. This method reduces the number of fabrication processes and aligns the substrate and the nozzle plate more precisely. This method is appropriate for a print head that requires a precise alignment and a high resolution.

The following description relates to a fabrication process of a general print head 10″ according to a monolithic method.

First, as shown in FIG. 3A, there is provided the silicone substrate 1 in which the heater 6 and a first protective layer 5 are disposed.

Next, as shown in FIG. 3B, a positive photo resist 8a′ having a thickness of several microns, e.g., 30-40 μm, is formed on the first protective layer 5 of the substrate 1. The positive photo resist 8a′ is patterned by a photolithography process of performing a UV light exposure and a developing by utilizing a photomask 8″, as shown in FIG. 3C.

As a result, as shown in FIG. 3D, a positive photo resist mold 8c′ of a sacrificial layer is formed on the first protective layer 5. Next, the positive photo resist mold 8c′ is etched and removed to thus provide a flow channel structure of the second ink supply channel 3 and the ink chamber 4.

After the formation of the positive photo resist mold 8c′ on the first protective layer 5, a whole surface of the substrate 1 is coated with a negative photo resist 9a′ as shown in FIG. 3E.

Next, as shown in FIG. 3F, the negative photo resist 9a′ is patterned by being exposed to a UV light and developed, by utilizing a photomask 9′ having a nozzle patterned therein. As a result, as shown in FIG. 3G, a chamber/nozzle plate 9a″ having the nozzle 7 formed therein is formed.

After the formation of the chamber/nozzle plate 9a″, as shown in FIG. 3H, on the chamber/nozzle plate 9a″ is formed a second protective layer 11 to protect the chamber/nozzle plate 9a″ in a subsequent etching step of forming the first ink supply channel 2.

Next, as shown in FIG. 3I, the substrate 1 is isotropically removed by wet or dry silicone etching so that the first ink supply channel 2 is formed in the substrate 1.

Next, the second protective layer 11 is removed and then the positive photo resist mold 8c′ not exposed to the UV is dissolved and removed by solvent, so that the flow channel structure of the ink chamber 4 and the second ink supply channel 3 is formed. The fabrication of the print head 10″ is completed.

Since such a monolithic method of fabricating the print head 10″ has the flow channel structure and the nozzle aligned by a heater through the photolithography process, no misalignment occurs. Accordingly, the monolithic method is advantageous in that the uniformity between cells and the injection and the printing performance per cell in the head do not deteriorate and there is no need for a process of adhering the nozzle plate and the substrate to each other. However, according to the monolithic method, there occurs a problem caused by the structure in which the negative photo resist 9a′ is formed on the positive photo resist mold 8c′. That is, when the negative photo resist 9a′ as an upper layer is coated on the positive photo resist mold 8c′ as a lower layer, the positive photo resist mold 8c′ is easily dissolved by the solvent of the negative photo resist 9a′. Thus, it is difficult to form an accurately sized flow channel structure of the ink chamber 4, the second ink supply channel 3, and a restrictor.

In order to prevent this problem, a positive photo resist which is durable against a negative photo resist can be used. However, drawbacks of this method are that it is difficult to have a coating layer thicker than 10 μm and a low UV photosensitivity does not allow a patterning of a sufficient depth.

Even if the positive photo resist which survives the negative photo resist is used, since it cannot act as an optimal positive photo resist allowing a coating of a sufficient thickness and a sufficient UV photosensitivity, the problem that the positive photo resist mold is dissolved by the solvent of the negative photo resist cannot be completely prevented.

Also, since the conventional monolithic fabrication method performs the photolithography process twice, one for the fabrication of the flow channel structure, the other for the fabrication of the nozzle, the fabrication process becomes complicated. Accordingly, there occur problems of increased fabrication costs and lowered productivity.

### SUMMARY OF THE INVENTION

Accordingly, it is an aspect of the present invention to solve the above problems in the related art.

It is another aspect of the present invention to provide a monolithic bubble ink-jet print head and a fabrication method thereof that integrate chamber and nozzle plates into a single photo resist, thereby preventing the problems of deterioration of size accuracy of a flow channel structure and uniformity between cells that occurs in the conventional monolithic fabrication method in which a photo resist including a chamber plate of a lower layer is dissolved when a nozzle plate of an upper layer is formed.

It is another aspect of the present invention to provide a monolithic bubble ink jet print head and a fabrication method that form a flow channel structure and a nozzle simultaneously by performing a photolithography process. Accordingly, there is less accumulation tolerance. Also, a boundary between an ink chamber and a nozzle is not formed, thereby increasing durability of a resulting structure and simplifying a fabrication process. Therefore, fabrication costs are decreased and productivity is improved.

Still another aspect of the present invention is to provide a monolithic bubble ink-jet print head and a fabrication method capable of easily changing sizes of a flow channel structure and a nozzle such as diameters, height, and so on by adjusting an amount of exposed light and a mask.

Additional aspects and advantages of the invention will be set forth in part in the description which follows and, in part, will be obvious from the description, or may be learned by practice of the invention.

The foregoing and/or other aspects of the present invention may be achieved by providing a substrate having a resistance body to heat ink and an ink supply opening penetrating through the substrate; and a chamber/nozzle plate including an ink chamber to hold the ink, a nozzle to eject the ink, and an ink supply channel to supply the ink from the ink chamber to the nozzle; and the chamber/nozzle plate being formed on the substrate by patterning a photo resist by a photolithography process using a single photo mask having at least two light transmission rates, so that the ink chamber, the ink supply channel and the nozzle are simultaneously formed.

The photo resist may be a negative photo resist having a thickness of 10 μm to 100 μm.

The photo resist may be made of a resin of a photosensitive epoxy group, a resin of a polyimid group, or a resin of a polyacrylate group.

The foregoing and/or other aspects of the present invention may also be achieved by providing a substrate having a resistance body formed on an upper surface thereof to heat ink; forming a photo resist on the substrate having the resistance body; exposing the photo resist to light by using a single photo mask having at least two light transmission rates; and developing the photo resist exposed to the light.

The forming of the photo resist may include forming the photo resist to have a thickness from 10 μm to 100 μm. The forming of the photo resist may also include forming the photo resist with a resin of a photosensitive epoxy group, a resin of a polyimid group, or a resin of a polyacrylate group.

The exposing of the photo resist to the light may use a photo mask having a metallic thin layer formed of at least two thicknesses to form a flow channel structure of an ink chamber, a restrictor, and an ink supply channel and a nozzle. A light source of the light may use a UV and the metallic thin layer may include a chrome layer or a chrome oxide layer.

The exposing of the photo resist to the light may include a UV light exposure with respect to the photo resist by using a photo mask including three parts. A first part has a relatively high UV transmission rate, a second part has a relatively low UV transmission rate, and a third part has a UV transmission rate of 0%, in order to form a flow channel structure and a nozzle. An amount of the exposed UV light may range from 2 mJ/cm² to 4000 mJ/cm² in order to adjust a hardening depth.

The developing of the photo resist may include selecting a developing liquid of the photo resist, and a solvent including a halogen element and an alkali solvent, and dissolving and removing the photo resist.

Also, the fabrication method may further include forming a protective layer on the photo resist after exposing the photo resist to the light, forming an ink supply opening penetrating through the substrate on a back surface of the substrate, and removing the protective layer.

The forming of the ink supply opening may include forming the ink supply opening by a dry etching, and cleaning an organic matter flowing into a surface of the substrate during the dry etching.

Also, the fabrication method may further include hard-baking the substrate in order to improve durability after developing of the photo resist.

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

FIG. 1 is a cross sectional view showing a general print head;

FIGS. 2A to 2D are views showing a process of fabricating a bubble ink jet print head according to a conventional adhering method;

FIGS. 3A to 3J are views showing a process of fabricating a bubble ink jet print head according to a conventional monolithic method;

FIGS. 4A to 4F are views showing a process of fabricating a bubble ink jet print head according to a monolithic method of an embodiment of the present invention;

FIGS. 5A and 5B are diagrams showing a hardening depth of a photo resist varying according to UV transmission of a photomask.

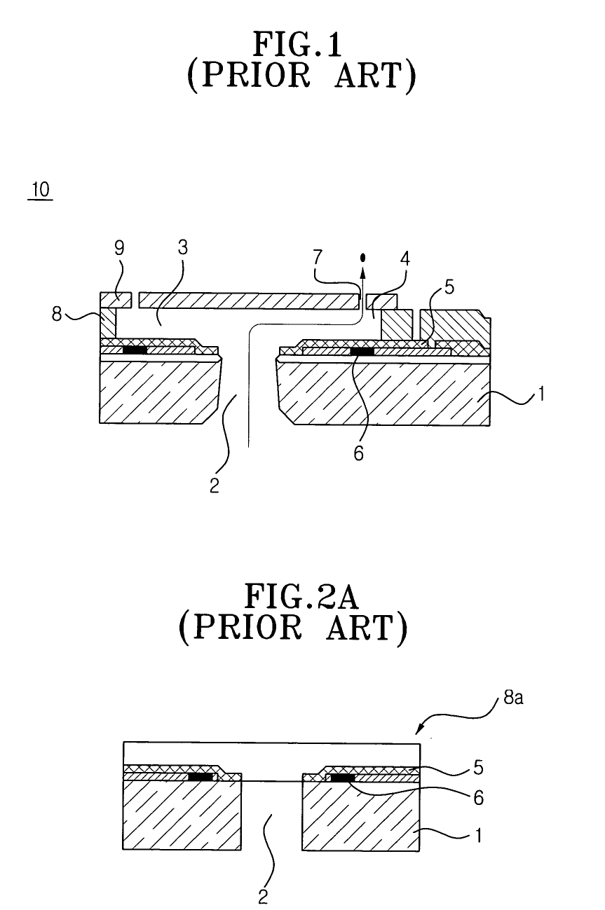

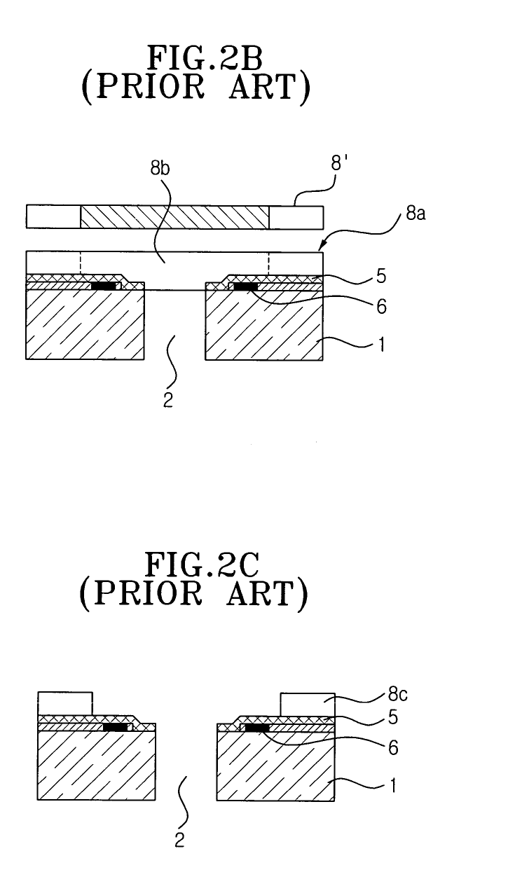

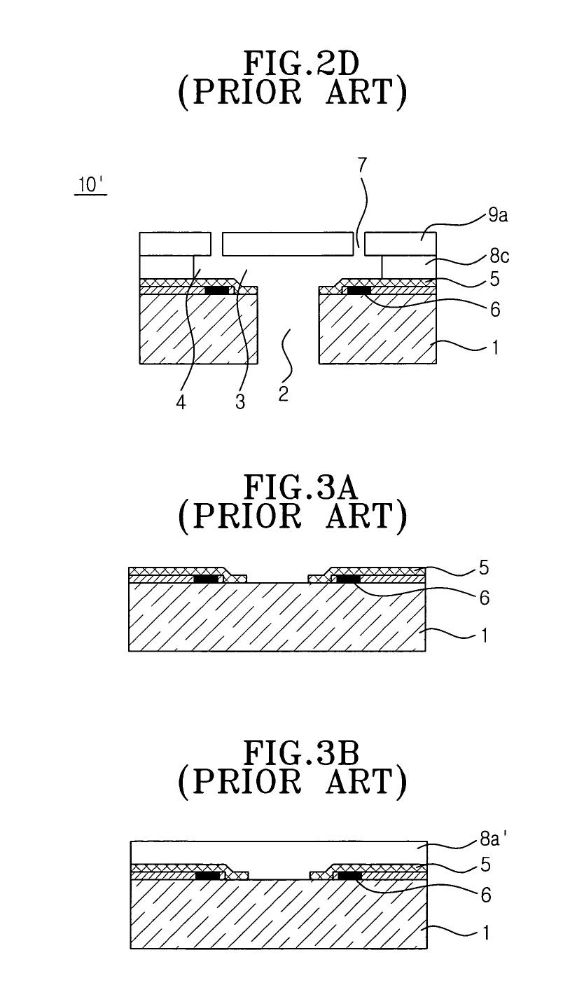

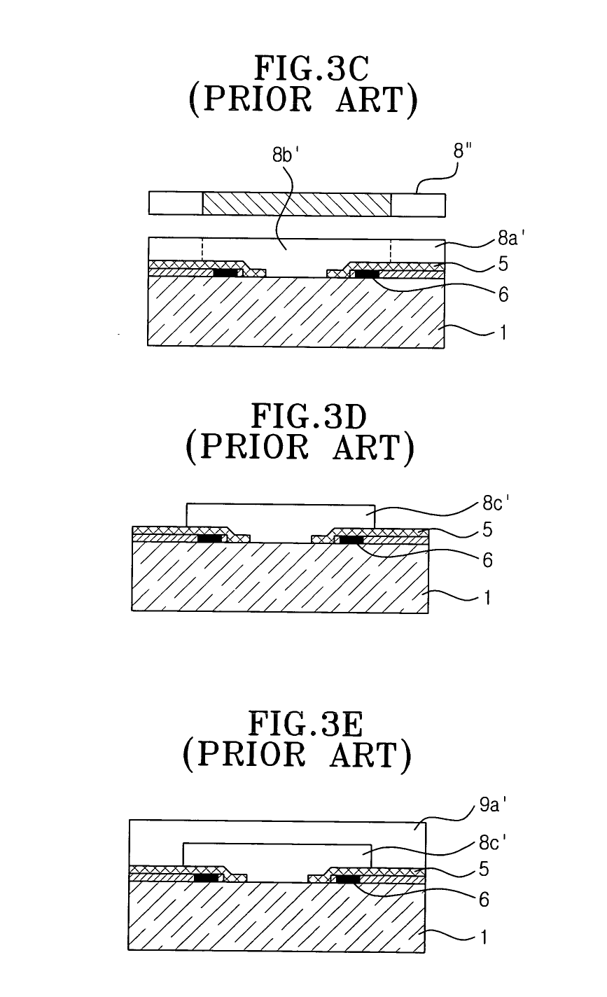

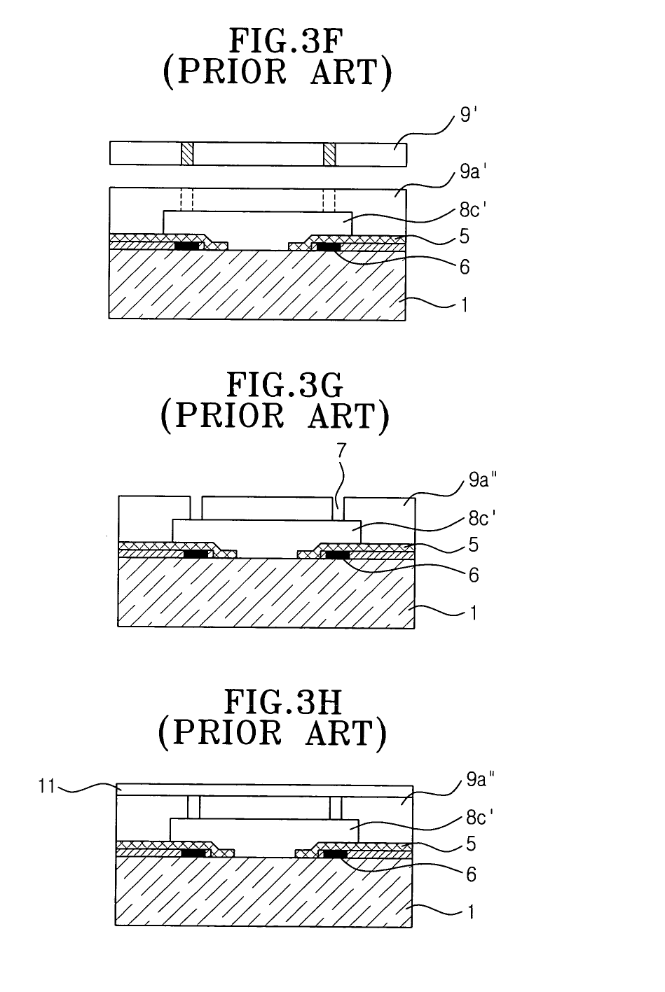

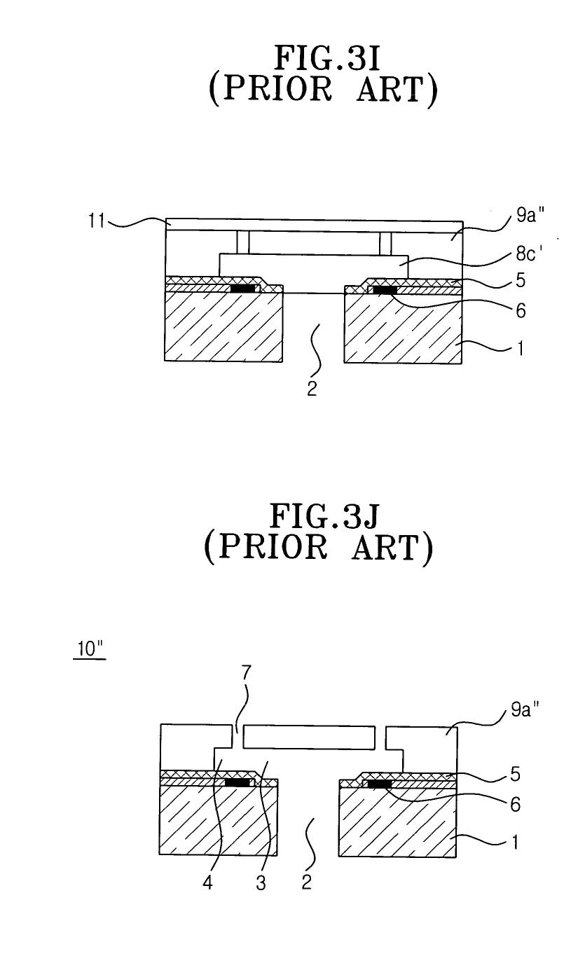

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout.

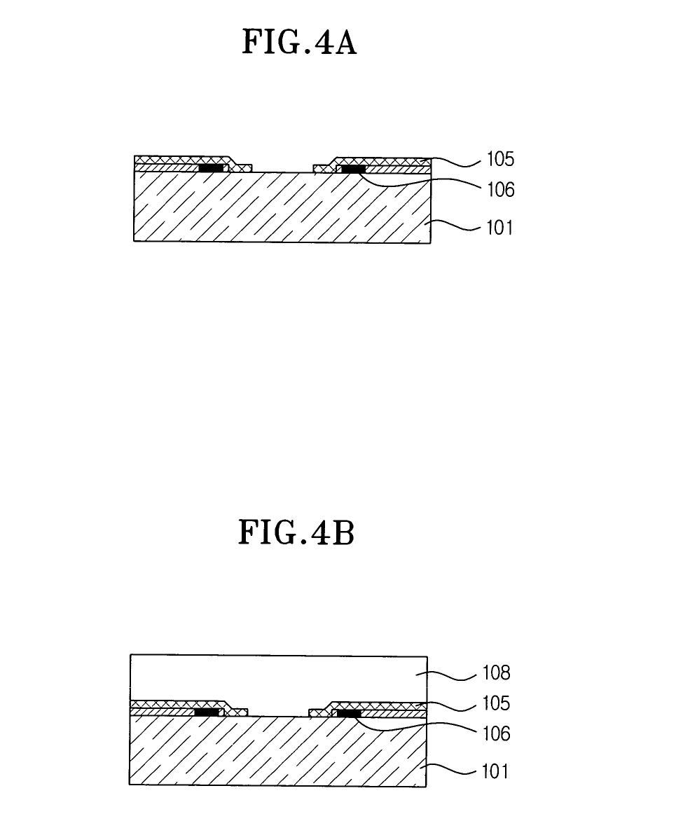

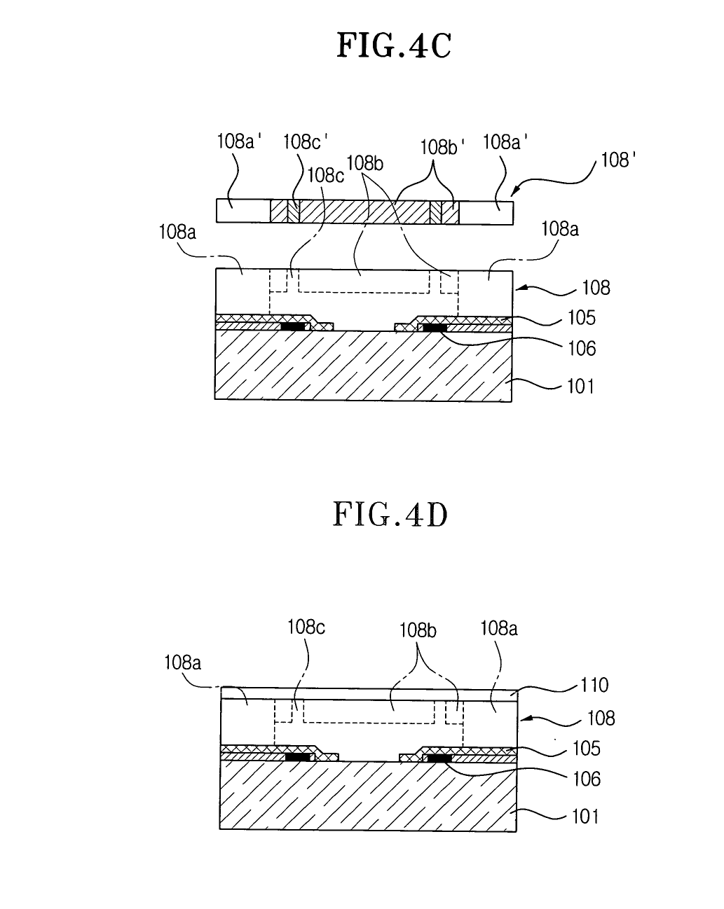

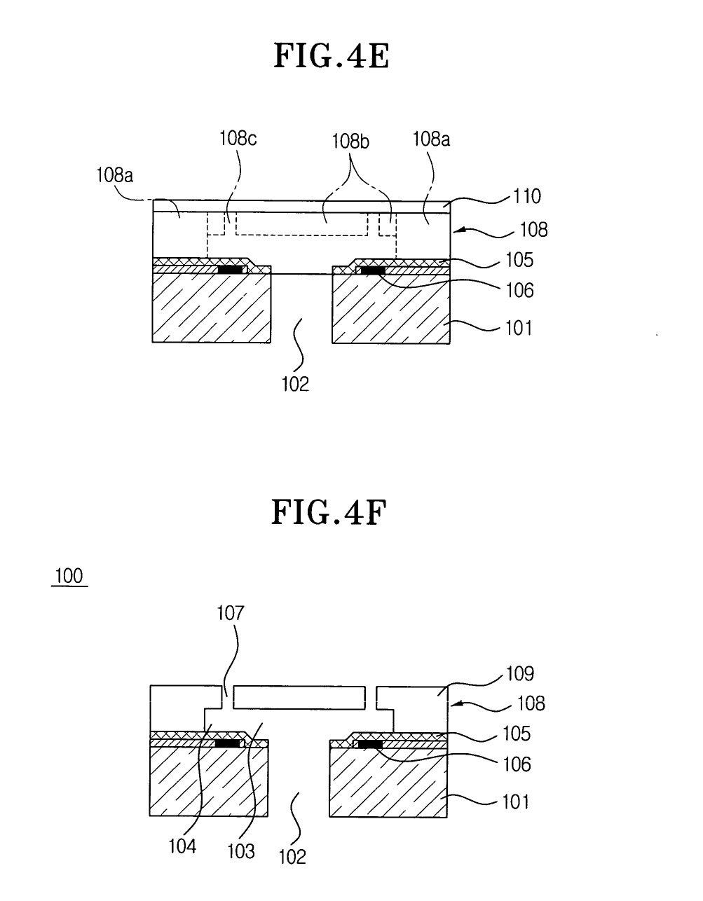

FIG. 4F shows a monolithic bubble ink jet print head 100 according to an embodiment of the present invention.

Referring to FIG. 4F, the print head 100 includes a silicon substrate 101 having a heater 106 to heat ink and a first protective layer 105 formed on the heater 106 to protect the heater 106, a first ink supply channel 102 including an ink supply opening penetrating through the substrate 101, and a chamber/nozzle plate 109 formed on the first protective layer 105 by patterning a negative photo resist 108 by a photolithography process utilizing a single photomask 108′ (Refer to FIG. 4C). The photomask 108′ has at least two different light transmission rates so as to simultaneously form a flow channel structure including an ink chamber 104, a restrictor (not shown), a second ink supply channel 103 and a nozzle 107.

The heater 106 includes a resistance heat emitting body such as poly silicon in which impurities are doped, shaped in a circle corresponding to a shape of the nozzle 107. The first protective layer 105 formed on the heater 106 is made of silicon nitride, silicon carbide and the like. If necessary, a metallic layer of Ta, TaN, TiN or the like is vapor-deposited on the first protective layer 105.

The chamber/nozzle plate 109 includes a first polymeric portion 108a (refer to FIG. 4D) that is cross-linked by being exposed to a relatively greater amount of UV light and includes a flow channel structure of the restrictor (not shown), the second ink supply channel 103, and the ink chamber 104, and a second polymeric portion 108b that is cross-linked by being exposed to a relatively lower amount of UV light and includes a pattern of the nozzle 107.

The chamber/nozzle plate 109 is made of any one of a resin of a photosensitive epoxy group such as SU-8 manufactured by MICROCHEM, a resin of a polyimid group such as DURAMID manufactured by ARCHCHEM, or a resin of a polyarcylate group such as a negative dry film resist manufactured by TOK and JSR.

Also, the chamber/nozzle plate 109 is formed by exposing to UV light and developing the photo resist 108 having a thickness ranging from 10 μm to 100 μm by utilizing the photomask 108′ (Refer to FIG. 4C) including three parts. A first part 108a′ having a maximum UV transmission rate, a second part 108b′ having a UV transmission rate of X %, and a third part 108c′ having a UV transmission rate of 0%.

A fabrication method of the monolithic bubble ink jet print head 100 will now be described.

As shown in FIG. 4A, there is a provided the silicon substrate 101 having the heater 106 and the first protective layer 105 formed therein.

At this point, the heater 106 is formed by selectively etching a relatively lower resistance metallic layer among metallic thin layers having high and low specific resistances, or by vapor-depositing a poly silicon in which impurities are doped on a front surface of the silicon substrate 101 and then patterning.

Next, as shown in FIG. 4B, on the first protective layer 105 of the substrate 101 is formed the negative photo resist 108. The negative photo resist 108 is made of any one of a resin of a photosensitive epoxy group such as a SU-8 manufactured by MICROCHEM, a resin of a polyimide group such as DURAMID manufactured by ARCHCHEM, or a resin of a polyarcyrlate group such as a negative dry film resist manufactured by TOK and JSR.

A thickness of the negative photo resist 108 is determined according to an amount of droplets which are discharged one at a time, which affects a resolution. The droplet amount depends on various flow channel structures such as the height of the ink chamber 104, the size of the restrictor, the diameter of the nozzle 107, and the size of the heater 106, which are classified by products. Accordingly, in order to satisfy the various flow channel structures, the negative photo resist 108 ranges from 10 μm to 100 μm in thickness.

Next, the negative photo resist 108 is exposed to the UV light by utilizing the photomask 108′ having at least two transmission rates, as shown in FIG. 4C.

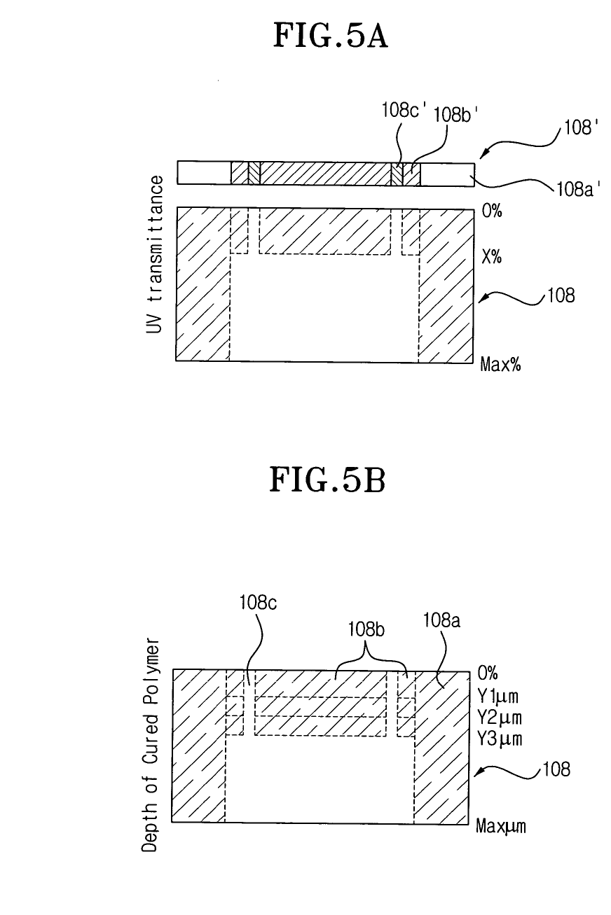

At this point, the amount of the exposed UV light ranges from 2 mJ/cm² to 4000 mJ/cm². Also, as shown in FIGS. 4C and 5A, the photomask 108′ includes three parts, the first part 108a′ having the flow channel structure and a maximum UV transmission rate, the second part 108b′ having a nozzle pattern and a UV transmission rate of X %, and the third part 108c′ having a UV transmission rate of 0%.

The UV transmission rates of the three parts 108a′, 108b′, and 108c′ of the photomask 108′ vary minutely depending on the type of the substrate 101 made of quartz, glass, nitriding layer and the like, but those of a photomask used in general UV lithography can be adjusted by varying the thickness of a metallic thin layer such as a chrome layer or a chrome oxide film.

In the case of using an X ray lithography instead of the UV lithography used in this embodiment, the light transmission rate can be adjusted by varying the thickness of the Au layer of the photomask.

FIG. 5B shows the depth of the negative photo resist 108 as photosensitized and hardened, varying in accordance with the UV transmission rates of the photo mask 108′.

Generally, when the negative photo resist 108 is exposed to the UV light by using the photomask 108′, the exposed first and second polymeric portions 108a and 108b change from low molecule to high molecule by the UV, causing crosslinking and thus causing a hardening phenomenon in which a network structure having a high crosslinking density in a high molecule is formed, while a non-exposed part 108c does not cause the crosslinking and thus is maintained in a monomer or oligomer state.

The parts first and second polymeric portions 108a and 108b hardened by being exposed to the UV light have a chemical resistance and a high mechanical hardness and thus are not dissolved by a developing liquid in a subsequent developing process, while the non-exposed part 108c of the photo resist 108 is dissolved and removed by the developing liquid in the subsequent developing process.

When the exposed first and second polymeric portions 108a and 108b are hardened, the crosslinking density of the network structure and the crosslinked depth are mostly adjusted by the amount of the light projected on the negative photo resist 108 through the photo mask 108′ having the UV transmission rate of the above-described pattern.

Also, the negative photo resist 108 has different optical absorption depending on the type and the content of a photosensitizer included in the negative photo resist 108 and UV frequency. Accordingly, as shown in FIG. 5B, even when identical UV is transmitted through the part 108b′ having a UV transmission of X %, the depth of the photo resist 108 hardened according to the type and content of the photosensitizer ranges from Y1 μm to Y3 μm.

As shown in FIG. 4D, after the negative photo resist 108 is exposed to the UV light by using the photo mask 108′, the negative photo resist 108 is coated with a second protective layer 110 including wax, a high molecular film, and the like.

After the formation of the second protective layer 110, a back surface of the substrate 101 is isotropically etched by dry and wet etching and removed, and as a result, a first ink supply channel 102 is formed, as shown in FIG. 4E.

After that, the part 108c of the negative photo resist 108 not exposed to the UV is dissolved and removed by a developing liquid, so that the chamber/nozzle plate 109 having a flow structure of the ink chamber 104, the second ink supply channel 103, the restrictor (not shown) and the nozzle 107 are formed.

At this point, the developing liquid affects the depth of the part 108a of the negative photo resist 108 that is not removed and remains to form the flow channel structure and the nozzle 107 according to the respective dissolving degree. Accordingly, the developing liquid is properly selected from a developing liquid of the negative photo resist 108, a solvent including a halogen element and an alkali solvent.

After the formation of the chamber/nozzle plate 109, a hard baking processing is performed with respect to the substrate 101 at a temperature of several tens or several hundreds of degrees for several tens of minutes or several tens of hours in order to adhere the chamber/nozzle plate 109 to the substrate 101 more closely, and the fabrication of the print head 100 is finally completed.

As described above, according to the monolithic bubble ink jet print head and the fabrication thereof, the nozzle plate and the chamber plate are integrated into a single photo resist. Accordingly, deterioration of size accuracy of the flow channel structure is prevented. Uniformity is achieved between cells necessary for the high resolution and the high speed printing that are caused by the dissolution of the photo resist of the chamber plate of the lower layer occurring in the conventional method when the nozzle plate of the upper layer is formed.

Also, since the present bubble ink jet print head and the fabrication method thereof forms the flow channel structure and the nozzle in the photolithography process at one time, a more precise photo alignment occurs. Since a boundary between the ink chamber and the nozzle is not formed, durability of the product is increased and the fabrication process is simplified and thus fabrication costs are reduced and productivity is improved.

Also, the present bubble ink jet print head and the fabrication thereof provides an effect that the sizes such as diameters and heights of the flow channel structure and the nozzle are easily changed by adjusting the amount of the exposed light and the mask.

Although a few preferred embodiments of the present invention have been shown and described, it will be appreciated by those skilled in the art that changes may be made in these embodiments without departing from the principles and spirit of the invention, the scope of which is defined in the claims and their equivalents.

What is claimed is:

1. A monolithic bubble ink jet print head comprising:
a substrate having a resistance body to heat ink and an ink supply opening penetrating through the substrate; and
a chamber/nozzle plate comprising:
an ink chamber to hold the ink,
a nozzle to eject the ink, and
an ink supply channel to supply the ink from the ink chamber to the nozzle,
the chamber/nozzle plate being formed on the substrate by patterning a photo resist by a photolithography process using a single photo mask having at least two light transmission rates, so that the ink chamber, the ink supply channel and the nozzle are simultaneously formed.

2. The monolithic bubble ink jet print head of claim 1, wherein the photo resist is a negative photo resist having a thickness of 10 μm to 100 μm.

3. The monolithic bubble ink jet print head of claim 2, wherein the photo resist is made of a resin of a photosensitive epoxy group, a resin of a polyimid group, or a resin of a polyacrylate group.

4. A fabrication method of a monolithic bubble ink jet print head comprising:
providing a substrate having a resistance body formed on an upper surface thereof to heat ink;
forming a photo resist on the substrate having the resistance body;
exposing the photo resist to light by using a single photo mask having at least two light transmission rates; and
developing the photo resist exposed to the light.

5. The method of claim 4, wherein the forming of the photo resist includes forming a negative photo resist.

6. The method of claim 5, wherein the forming of the photo resist includes forming the photo resist to have a thickness from 10 μm to 100 μm.

7. The method of claim 5, wherein the forming of the photo resist includes forming the photo resist with a resin of a photosensitive epoxy group, a resin of a polyimid group, or a resin of a polyacrylate group.

8. The method of claim 6, wherein the forming of the photo resist includes forming the photo resist with a resin of a photosensitive epoxy group, a resin of a polyimid group, or a resin of a polyacrylate group.

9. The method of claim 4, wherein the photo mask used during the exposing of the photo resist to the light has a metallic thin layer formed of at least two thicknesses to form a flow channel structure of an ink chamber, an ink supply channel and a nozzle.

10. The method of claim 9, wherein a source of the light uses UV light and the metallic thin layer is a chrome layer or a chrome oxide layer.

11. The method of claim 4, wherein the exposing of the photo resist to the light comprises exposing the photo resist to UV light, and the photo mask comprises:
a first part having a relatively high UV transmission rate,
a second part having a relatively low UV transmission rate, and
a third part having a UV transmission rate of 0%,
to form a flow channel structure of the ink chamber, and the ink supply channel and the nozzle.

12. The method of claim 10, wherein an amount of the UV is between 2 mJ/cm² and 4000 mJ/cm² to adjust a hardening depth.

13. The method of claim 11, wherein an amount of the UV is between 2 mJ/cm² and 4000 mJ/cm² in order to adjust a hardening depth.

14. The method of claim 4, wherein the developing of the photo resist comprises:
selecting a developing liquid of the photo resist, and a solvent including a halogen element, and an alkali solvent; and
dissolving and removing the photo resist.

15. The method of claim 4, further comprising:
forming a protective layer on the photo resist after exposing the photo resist to the light;
forming an ink supply opening penetrating through the substrate on a back surface of the substrate; and
removing the protective layer.

16. The method of claim 15, wherein the forming of the ink supply opening comprises:
forming the ink supply opening by a dry etching; and
cleaning an organic matter flowing into a surface of the substrate during the dry etching.

17. The method of claim 15, wherein the forming of the ink supply opening comprises:
forming the ink supply opening by a wet etching; and
cleaning an organic matter flowing into a surface of the substrate during the wet etching.

18. The method of claim 4, further comprising hard-baking the substrate after the developing of the photo resist.

19. A method comprising:
providing a substrate;
forming a photo resist on the substrate;
exposing the photo resist to light by using a single photo mask having first and second light transmission rates; and
developing the exposed photo resist.

20. The method of claim 19, wherein the developing comprises forming a chamber/nozzle plate of a monolithic bubble ink jet print head.

21. The method of claim 20, wherein the developing further comprises forming an ink chamber, an ink supply channel, and a nozzle in the chamber/nozzle plate simultaneously.

22. The method of claim 19, further comprising providing a heater on the substrate.

23. The method of claim 21, further comprising:
exposing a first polymeric portion of the chamber/nozzle plate to a first amount of the light; and
exposing a second polymeric portion of the chamber/nozzle plate to a second amount of the light, which is lower than the first amount of the light.

24. The method of claim 23, wherein the first polymeric portion comprises the ink chamber and the ink supply channel, and the second polymeric portion comprises the nozzle.

25. The method of claim 19, wherein the exposing the photo resist to light comprises exposing the photoresist to UV light.

26. The method of claim 19, further comprising coating the photo resist with a protective layer formed of wax or a high molecular film.

27. The method of claim 19, further comprising:
varying an optical absorption of the photo resist so that a depth of the developed photo resist varies.

28. The method of claim 27, wherein the varying of the optical absorption of the photo resist comprises providing a photosensitizer in the photo resist.

29. The method of claim 28, wherein the exposing of the photo resist to the light comprises exposing the photo resist having varying optical absorption to identical light.

30. The method of claim 21, wherein the forming the nozzle and the ink chamber comprises forming the ink chamber and the nozzle without a boundary therebetween.
